(19) United States
(12) Patent Application Publication
(10) Pub. No.: US 2015/0064335 A1
(43) Pub. Date: Mar. 5, 2015

(54) POTATO FOOD PRODUCTS AND METHODS AND SYSTEMS RELATED THERETO

(71) Applicant: Carl Hoverson, Larimore, ND (US)

(72) Inventor: Carl Hoverson, Larimore, ND (US)

(21) Appl. No.: 14/384,864

(22) PCT Filed: Mar. 12, 2013
(86) PCT No.: PCT/US13/30473

§ 371 Date: Sep. 12, 2014

Related U.S. Application Data
(60) Provisional application No. 61/610,299, filed on Mar. 13, 2012.
(60) Provisional application No. 61/753,805, filed on Jan. 17, 2013.

(51) Int. Cl. A23L 1/217; B07C 5/34; G01N 9/36

(52) U.S. Cl. CPC A23L 1/217; G01N 9/36; B07C 5/34; A23V 2002/00
USPC 426/637; 209/552

(57) ABSTRACT

This disclosure describes, in one aspect, a food product prepared from a plurality of potatoes in which at least 51% of the potatoes possess a specific gravity of at least 1.086. In some embodiments, the food product can receive a color sensory grade, a texture sensory grade, a flavor sensory grade, and/or a composite sensory grade of at least 7.0.

### CROSS-REFERENCE TO RELATED APPLICATION

This application claims priority to U.S. Provisional Patent Application Ser. No. 61/610,299, filed Mar. 13, 2012, and U.S. Provisional Patent Application Ser. No. 61/753,805, filed Jan. 17, 2013, each of which is incorporated herein by reference.

### SUMMARY

This disclosure describes, in one aspect, a method that generally includes providing a recipient with a plurality of potatoes in which at least 51% of the potatoes possess a specific gravity of at least 1.086.

In another aspect, this disclosure describes a method that generally includes making a potato food product from a plurality of potatoes in which at least 51% of the potatoes possess a specific gravity of at least 1.086. In some embodiments, the method can include making French fries (e.g., fresh-cut French fries) or potato chips. In some embodiments, the food product can include acrylamide in an amount no greater than 500 ppb.

In another aspect, this disclosure describes a food product prepared from a plurality of potatoes in which at least 51% of the potatoes possess a specific gravity of at least 1.086. In some embodiments, the food product can include French fries, fresh-cut French fries, or potato chips. In some embodiments, the food product can include acrylamide in an amount no greater than 500 ppb. In some embodiments, the food product can receive a color sensory grade, a texture sensory grade, a flavor sensory grade, and/or a composite sensory grade of at least 7.0.

In yet another aspect, this disclosure describes a system that generally includes a specific gravity meter and a selector in communication with the specific gravity meter configured to separate potatoes having a specific gravity at least as great as a predetermined value from potatoes having a specific gravity less than the predetermined value.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1 is a photograph showing a comparison of French fried potatoes prepared using (A) potatoes selected by conventional methods and (B) potatoes selected as described herein.

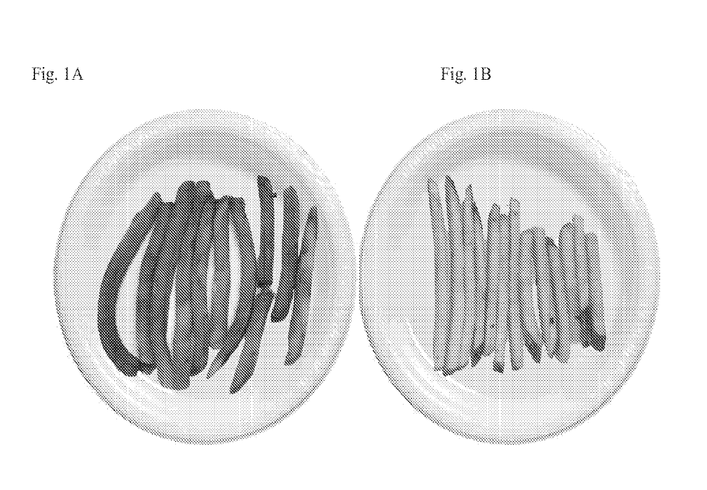

### DETAILED DESCRIPTION OF ILLUSTRATIVE EMBODIMENTS

This disclosure describes potato food products, methods related to producing the potato food products, and a system related to the methods. Generally, the disclosure relates to producing potato food products such as, for example, French fries (particularly fresh-cut French fries), potato chips, or hash browns that can require less labor for production and can have reduced amounts of oils and/or carbohydrates, yet maintain desirable sensory characteristics such as, for example, appearance, taste, and texture.

Many conventional commercial potato food products are produced from potatoes that have a specific gravity from about 1.075 to about 1.085. Fresh-cut French fries produced from such potatoes often can have a limp texture, can absorb oil while cooking producing a greasy, oily French fry, and can exhibit a brown color after cooking.

In contrast, this disclosure describes food products—and methods and systems related to those food products—based on selecting potatoes with a higher specific gravity than the range of specific gravities currently considered the conventional commercial standard. As a result, food products produced from potatoes selected as described herein can have less fat, fewer calories, require less labor, have greater storage flexibility, and/or produce a food product with a greater sensory grade than comparable food products prepared with conventionally selected potatoes.

Throughout this disclosure, food products and certain methods are described in the context of fresh-cut French fries. As used herein “fresh-cut” refers to French fried potatoes that are made from potatoes that have not been blanched, pre-soaked, or frozen, and may or may not include potato skin. However, other food products such as, for example, French fries made by processes other than fresh-cut processes, potato chips, hash browns, fried potato cakes, baked potatoes, and mashed potatoes can be made from potatoes as described herein using conventional methods for preparing those food products.

Potato food products can be improved by selecting potatoes that have a specific gravity of no less than a predetermined value. In many embodiments, the predetermined value for specific gravity is 1.086. As noted below in more detail, however, in some embodiments the predetermined value for specific gravity of the potato may be, for example, 1.088, 1.090, 1.092, or 1.096. As used herein, “specific gravity” refers to the ratio of the density of a potato compared to water under atmospheric pressure and at a temperature of 72° F.

Food products prepared from potatoes having a specific gravity greater than the predetermined value may be subjected to sensory grading. For example, French fries may be subjected to sensory grading as described in Jahner et al. Farm Research (1983), 41(3): 20-22. The sensory grading described in Jahner et al. involves trained personnel grading sensory attributes of a food product on a scale of 1-9 in three categories: taste, texture, and appearance. The product is then given a composite grade that is an average of the scores in each category.

Raw potatoes that possess a specific gravity of at least 1.086 and that can produce, for example, a fresh-cut French fry that receives a sensory grade of, for example, at least 7.0 can possess one or more desirable qualities compared to potatoes selected by conventional selection processes.

For example, fresh-cut French fries prepared from potatoes selected as described herein can exhibit a longer “hold time” to maintain freshness, firmness, and flavor after frying. As used herein, “hold time” refers to the amount of time after cooking that a French fry can hold its appearance, texture, and flavor. Beyond the “hold time,” cooked French fries are typically discarded as unsuitable to be served to patrons, resulting in waste. Thus, potatoes that can extend hold time can reduce the cost of waste and/or reduce patron dissatisfaction from having been served “old” French fries.

As another example, fresh-cut French fries prepared from potatoes selected as described herein can produce, for example, a fresh-cut French fry with superior taste, texture, and appearance without laborious pre-preparation steps such as, for example, pre-soaking, pre-frying, and/or blanching. Conventional methods for making fresh-cut French fries, for example, typically involve pre-soaking, pre-frying, and/or blanching the potatoes before frying. Pre-soaking and/or blanching may be done to remove at least some of the sugars from the cut surfaces of the potatoes and/or to remove moisture from the cut potatoes. In the absence of such pre-soaking or blanching, fresh-cut French fries prepared from conventionally selected potatoes can lack crispness. In contrast, fresh-cut French fries prepared from potatoes as described herein may be prepared by simply cutting the potatoes and frying, reducing labor associated with the pre-soaking and/or blanching steps.

Potatoes selected as described herein also can reduce production costs because the raw potatoes can be stored for up to 13 months and still deliver consistent quality to finished food products. Moreover, potatoes selected as described herein can be stored at a temperature as low as 42° F. In contrast, Russett Burbank potatoes having a specific gravity between 1.075 and 1.085, a common conventional fresh-cut French fry potato, cannot be stored at temperatures below 48° F. Thus, potatoes selected as described herein can provide greater storage flexibility and can therefore reduce storage costs.

In some embodiments, the potato food product may be cooked in, on, or otherwise with an oil. Exemplary cooking methods involving oil include, for example, deep frying (as may be used to prepare, for example, French fries or potato chips) or pan frying (as made be used to prepare, for example, hash browns or potato cakes). In such embodiments, the potato food product prepared from potatoes selected as described herein may be prepared with less frying time than a similar potato food product prepared from potatoes selected using conventional methods. For example, as indicated above, preparing fresh-cut French fries from conventionally selected potatoes can involve a pre-frying step in which cut, then blanched and/or pre-soaked potatoes are pre-fried for, for example, approximately 2.0-3.5 minutes, removed from the fryer, then fried a second time for approximately 3.0-3.5 minutes. In contrast, potatoes selected as described herein can be fully cooked in a single fry of approximately 4 5 minutes. Thus, typical current fresh-cut French fries are produced by a method that involves cutting, blanching and/or pre-soaking, pre-frying for 2.0-3.5 minutes, then frying for 3.0-3.5 minutes. With potatoes selected as described herein, fresh-cut French fries can be produced by a method that involves cutting and frying for approximately 4.5 minutes.

Moreover, potatoes selected as described herein can absorb less oil during the frying process due, at least in part, to the reduced frying time required, but perhaps also because the potatoes may be less susceptible to absorbing oil. Thus, fresh-cut French fries prepared from potatoes selected as described herein can absorb less oil than conventional fresh-cut French fried potatoes, which can have at least two consequences. First, less oil may be need for the cooking process, once again reducing the cost of preparing fresh-cut French fries. Second, the resulting French fries can have less fat in the form of absorbed oil and, therefore, fewer calories.

Fresh-cut French fries prepared from potatoes as described herein can score higher on formal sensory evaluations. Sensory evaluations typically grade the color, texture, and flavor. Sensory evaluations are typically performed by trained personnel as described in Jahner et al. Farm Research (1983), 41(3): 20-22. Analogous sensory grading schemes exist for other potato food products. Different varieties of potato can receive different sensory grades. Thus, to optimize food products, selecting potatoes by a predetermined specific gravity is only one part of the process. Potatoes that can attain a predetermined specific gravity at an acceptable level of consistency can be evaluated for sensory grades. Those with suitably high sensory grades can be selected for commercial production of the food products.

As noted above, sensory grading of a food product such as, for example, French fries, can involve evaluation by trained personnel of certain sensory attributes—e.g., the color, texture, and flavor—of the product. As described in Jahner et al., sensory attributes of the food product may be graded by trained personnel in a controlled environment on a scale of 1-9 (1-inedible to 9-excellent). The product may be given a composite score on a scale of 1-9 that is the average of the scores for each of the attributes.

In some embodiment, potatoes selected as described herein can be used to produce a food product that possesses a predetermined composite sensory grade. In other embodiments, one or some combination of sensory grades for individual attributes may be considered. Thus, in various embodiments, a finished food product prepared from potatoes selected as described herein can possess a sensory grade that reflects a predetermined composite sensory grade, a predetermined color sensory grade, a predetermined texture sensory grade, and/or a predetermined flavor sensory grade. In some embodiments, a predetermined sensory grade—whether reflecting a composite sensory grade, a color sensory grade, a texture sensory grade, or a flavor sensory grade—can have a minimum of at least 7.0 such as, for example, at least 7.1, at least 7.2, at least 7.3, at least 7.4, at least 7.5, at least 7.6, at least 7.7, at least 7.8, at least 7.9, at least 8.0, at least 8.1, at least 8.2, at least 8.3, at least 8.4, at least 8.5, at least 8.6, at least 8.7, at least 8.8, or at least 8.9. In some embodiments, a predetermined sensory grade can have a maximum of no more than 9.0, no more than 8.9, no more than 8.8, no more than 8.7, no more than 8.6, no more than 8.5, no more than 8.4, no more than 8.3, no more than 8.2, no more than 8.1, no more than 8.0, no more than 7.9, no more than 7.8, no more than 7.7, no more than 7.6, no more than 7.5, no more than 7.4, no more than 7.3, no more than 7.2, no more than or no more than 7.1. In some embodiments, a predetermined sensory grade can be expressed as a range having as endpoints defined by any minimum sensory grade listed above and any maximum sensory grade listed above that is greater than the minimum sensory grade.

Finally, when certain foods, including potatoes, are cooked at temperatures exceeding 120° F., acrylamide can be produced. Acrylamide results from chemical reaction that occurs at high temperatures between the amino acid asparagine, found in proteins, and certain sugars that are common in potatoes. Acrylamide exposure can increase risk of certain types of cancers, although the dietary exposure required to increase such risks is not clear. Fresh-cut French fries prepared using potatoes as described herein can include less than 300 parts per billion (ppb) acrylamide, compared to more than 1200 ppb for many conventional fresh-cut French fries.

As described above, potato food products can be improved by selecting potatoes that have a specific gravity of no less than a predetermined value. In many embodiments, the predetermined value can be 1.086 such as, for example, 1.087, 1.089, 1.089, 1.090, 1.091, 1.092, 1.093, 1.094, 1.095, 1.096, 1.097, 1.098, 1.099, or 1.100. The predetermined value can be expressed as a range having endpoints defined by a first specific gravity value from those listed and any second specific gravity value that is different than the first specific gravity value. For example, the predetermined value for specific gravity can range from at least 1.086 to no more than 1.100 such as, for example, 1.092-1.100, 1.088-1.098, 1.092-1.098, 1.092-1.096, 1.096-1.100, 1.090-1.096, or 1.096-1.098. In certain embodiments, the predetermined value of specific gravity can be 1.096.

Specific gravity of a potato may be measured using conventional methods. Such methods can include using, for example, a buoyant force transducer. The buoyancy force produced by a float in a homogeneous liquid is equal to the weight of the liquid that is displaced by the float. Since buoyancy force is linear with respect to the density of the liquid within which the float is submerged, the measure of the buoyancy force yields a measure of the density of the liquid. Commercially available instruments can be capable of measuring specific gravity with an accuracy of +/−0.001 SG units.

Without wishing to be bound by any particular theory, potatoes having a specific gravity of at least 1.086 are denser than potatoes having a specific gravity within the conventional range of specific gravities considered commercially acceptable for producing, for example, fresh-cut French fries and/or potato chips. A higher specific gravity generally corresponds to a potato having less water than a potato with a lower specific gravity. Decreasing moisture content in potatoes prior to frying is known to increase the crispness of the cooked potato product. However, within the confines of the commercially accepted range of specific gravities, water content remains a challenge. Thus, conventional measures for improving the crispness of fried potato food products typically include pre-cooking processing to reduce the moisture content of the potato. Such processes include, for example, blanching and/or pre-frying.

Similarly, a potato selected as described herein can possess lower amounts of sugars than a potato with a lower specific gravity. When cut, these sugars can remain on the cut surface. Sugars on the surface can brown faster than the inside of the cut potato cooks, which can result in dark, yet undercooked French fries. Conventional measures for reducing the amount of sugars on the cut surfaces of potatoes include, for example, soaking the cut potatoes prior to cooking.

Also, the type of starch present in a potato can affect the quality of food products produced from the potato. For example, two common forms of starch found in potatoes are amylose and amylopectin. Potatoes selected as described herein tend to have a higher amylose:amylopectin ratio. Amylopectin is a waxier starch, typically associated with, for example, red potatoes.

By selecting potatoes as described herein, one can prepare food products from potatoes that naturally possess lower moisture and can possess lower amounts of sugars than potatoes that have a specific gravity within the conventional commercially acceptable range for making, for example, fresh-cut French fries.

The specific gravity of a potato—or a portion of a crop of potatoes—can depend at least in part on many factors. Moreover, obtaining consistency in specific gravity values can be challenging. Thus, while no one factor, alone, is sufficient to consistently produce potatoes having a predetermined specific gravity, growing potatoes under conditions selected to reflect conditions that promote the growth of potatoes that reach a particular specific gravity can increase the ratio of potatoes in a given growing area that attain the particular specific gravity. Such factors include, for example, the variety of potato being grown, the soil in which the potato is grown, and the climate in which the potato is grown.

One factor that can influence the consistency with which a potato can be grown to attain a predetermined specific gravity is the variety of potato. One variety capable of consistently being grown to a specific gravity of at least 1.086 under appropriate conditions is a Dakota Trailblazer (Farnsworth et al. 2010, The Potato Association of America. Paper No. 89, p. 101). The Dakota Trailblazer (AOND95249-1 Russ) produces food products that also consistently receive high sensory grades. Other varieties that can be grown to consistently attain a specific density of at least 1.086 include, for example, ND8229-3 (Dakota Russett), ND8068-5 Russ, ND 049289-1 Russ, ND 059694B-200 Russ, ND8220-3, ND2676-10 (Dakota Pearl), and ND5822C-7 (Dakota Diamond).

In contrast, the Russett Burbank is common conventional potato variety for use in preparing, for example, fresh-cut French fries. Russett Burbank potatoes, however, typically have a specific gravity of approximately 1.075 to approximately 1.085.

In certain embodiments, it may be desirable to select a variety of potato that can be grown to consistently attain a predetermined specific gravity in each of a variety of growing regions such as, for example, North Dakota, Idaho, and/or Washington/Oregon. AOND95249-1 Russ (Dakota Trailblazer), ND8229-3 (Dakota Russett), ND8068-5 Russ, ND 049289-1 Russ, ND 059694B-200 Russ, ND8220-3, ND2676-10 (Dakota Pearl), and ND5822C-7 (Dakota Diamond) are examples of such varieties. In other embodiments, however, it may be sufficient to select a potato that can be grown to consistently attain a predetermined specific gravity in one or more growing regions even if it does not necessarily consistently grow to attain a predetermined specific gravity in more growing regions. Exemplary varieties in this class can include, for example, the Ranger Russett, Premiere Russett, and the Kennebec. The Ranger Russett, for example, can be grown to attain a specific gravity of at least 1.090 in North Dakota, a specific gravity of 1.088 in Idaho, and a specific gravity of 1.082 in Washington. Thus, in certain embodiments—e.g., those with a minimum specific gravity of 1.088—Ranger Russetts grown in Idaho or North Dakota may be suitable. In other embodiments—e.g., those with a minimum specific gravity of 1.090—Ranger Russets grown in North Dakota may be suitable. Similarly, the Premiere Russett can be grown to consistently attain a specific gravity of at least 1.090 in North Dakota (1.091), but it fails to grow consistently to a specific gravity of 1.090 in either Idaho or Washington (1.087 and 1.077, respectively)

The soil in which the potatoes are grown also can influence the specific gravity of potatoes in the crop. Soils having organic content of at least 2% are conducive to growing potatoes with a higher specific gravity. The soil also can influence the flavor of the potato and, consequently, food products prepared from the potatoes. For example, organic soils with natural potassium at a level of at least 200 parts per million (ppm) and/or natural calcium at a level of at least 2,000 ppm are conducive to growing potatoes that can be used to prepare food products receiving higher flavor sensory grades than food products prepared from potatoes grown in soils with less potassium and/or calcium.

Climate also can influence the specific gravity of potatoes. Longer daylight hours, warm days (average daytime high temperature of approximately 75° F.) and cooler nights (average nighttime low temperature of approximately 55° F.) during the growing season are conducive to growing potatoes with a higher specific gravity. Climates in which average daytime high temperatures and/or average nighttime low temperatures are warmer can decrease the consistency with which potatoes can be grown to a specific gravity as high as described herein.

Thus, in one aspect, the invention provides a method that includes providing to a recipient a plurality of potatoes in which at least 51% of the potatoes possess a specific gravity of at least a predetermined value. As used herein, a “recipient” refers to any person, company, corporation, institution, or other entity regardless of whether the recipient is charged for and/or pays for potatoes as provided in the method.

With respect to this method and any other aspect of the invention that specifies a particular percentage of plurality of potatoes possessing a predetermined specific gravity, the percentage of the potatoes that possess the predetermined specific gravity can be, in various embodiments, any percentage that ranges from 51% to 100%. Thus, in some embodiments, the percentage of potatoes so specified may be a minimum of 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%. In some embodiments, the percentage of potatoes so specified may be a maximum of 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100%. In some embodiments, the percentage of potatoes so specified can be expressed in terms of a range having endpoints defined by any minimum percentage listed above and any maximum percentage listed above greater than the minimum percentage.

In another aspect, the invention provides a method that generally includes making a food product from a plurality of potatoes in which at least 51% of the potatoes possess a specific gravity of at least a predetermined value. As used herein, “a food product” made “from a plurality of potatoes” is not meant to imply that a single serving or even a single batch must necessarily be prepared from a plurality of potatoes. Rather, the term “making a food product from a plurality of potatoes” is meant to include the actions of proprietor—whether a person, company, corporation, institution, or other entity—who, in the normal course of business, may prepare food product from a plurality of the specified potatoes. Thus, for example, while a single serving of fresh-cut French fries may be prepared from a single potato, the term is intended to cover activity in which, through the normal course of business, a proprietor prepares a plurality of servings of food product using a plurality of potatoes. In some embodiments, the method can include preparing French fries, potato chips, or hash browns. In some of these embodiments, the French fries can include fresh-cut French fries. Such methods can include using conventional commercial grade preparatory tools such as a fry cutter (Nemco Food Equipment, Ltd., Hicksville, Ohio) and a fryer (CuliNex LLC, Bainbridge Island, Wash.).

Thus, in another aspect the invention provides a food product prepared from a plurality of potatoes in which at least 51% of the potatoes possess a specific gravity of at least a predetermined value. In some embodiments, the food product can include French fries (e.g., fresh cut French fries) or potato chips.

In some of the embodiments of aspects that refer to a food product, the food product can include acrylamide in an amount no greater than 900 ppb such as, for example, no greater than 800 ppb, no greater than 700 ppb, no greater than 600 ppb, no greater than 500 ppb, no greater than 450 ppb, no greater than 400 ppb, no greater than 350 ppb, no greater than 300 ppb, no greater than 290 ppb, no greater than 280 ppb, no greater than 270 ppb, no greater than 260 ppb, or no greater than 250 ppb, no greater than 240 ppb, no greater than 230 ppb, no greater than 220 ppb, no greater than 210 ppb, no greater than 200 ppb, no greater than 190 ppb, no greater than 180 ppb, no greater than 170 ppb, no greater than 160 ppb, no greater than 150 ppb, no greater than 140 ppb, no greater than 130 ppb, no greater than 120 ppb, no greater than 110 ppb, no greater than 109 ppb, no greater than 108 ppb, no greater than 107 ppb, no greater than 106 ppb, no greater than 105 ppb, no greater than 104 ppb, no greater than 103 ppb, no greater than 102 ppb, no greater than 101 ppb, no greater than 100 ppb, no greater than 90 ppb, no greater than 80 ppb, no greater than 70 ppb, no greater than 60 ppb, no greater than 50 ppb, or no greater than 40 ppb. In particular embodiments, the food product can include acrylamide in an amount no greater than 150 ppb. In one particular embodiment, a food product prepared using ND8229-3 (Dakota Russett) selected as described herein can include no more acrylamide than 80 ppb such as, for example, 78 ppb.

In another aspect, the invention provides a system that generally includes a specific gravity meter and a selector in communication with the specific gravity meter. Generally, the selector is configured to separate potatoes having a specific gravity at least as great as a predetermined value from potatoes having a specific gravity less than the predetermined value. In some embodiments, the specific gravity meter measures the specific gravity of one or a plurality of potatoes. The specific gravity meter can include, for example, a buoyant force transducer.

### EXEMPLARY EMBODIMENTS

### Embodiment 1

A method comprising: providing a recipient with a plurality of potatoes in which at least 51% of the potatoes possess a specific gravity of at least 1.086.

### Embodiment 2

A method comprising: making a potato food product from a plurality of potatoes in which at least 51% of the potatoes possess a specific gravity of at least 1.086.

### Embodiment 3

The method of Embodiment 2 wherein the potato food product comprises French fries.

### Embodiment 4

The method of Embodiment 3 wherein the French fries comprise fresh-cut French fries.

### Embodiment 5

The method of any one of Embodiments 2-4 wherein the food product comprises potato chips.

### Embodiment 6

The method of any one of Embodiments 2-5 wherein the food product comprises acrylamide in an amount no greater than 500 ppb.

### Embodiment 7

A food product prepared from a plurality of potatoes in which at least 51% of the potatoes possess a specific gravity of at least 1.086.

### Embodiment 8

The food product of Embodiment 7 comprising French fries.

### Embodiment 9

The food product of Embodiment 8 wherein the French fries comprise fresh-cut French fries.

### Embodiment 10

The food product of Embodiment 7 comprising potato chips.

### Embodiment 11

The food product of Embodiment 7 comprising hash browns.

### Embodiment 12

The food product of any one of Embodiments 7-11 comprising acrylamide in an amount no greater than 500 ppb.

### Embodiment 13

The food product of any one of Embodiments 7-12 further comprising a composite sensory grade of at least 7.0.

### Embodiment 14

A system comprising: a specific gravity meter; and a selector in communication with the specific gravity meter and configured to separate potatoes having a specific gravity at least as great as a predetermined value from potatoes having a specific gravity less than the predetermined value.

In the preceding description, particular embodiments may be described in isolation for clarity. Unless otherwise expressly specified that the features of a particular embodiment are incompatible with the features of another embodiment, certain embodiment can include a combination of compatible features described herein in connection with one or more embodiments.

For any method disclosed herein that includes discrete steps, the steps may be conducted in any feasible order. And, as appropriate, any combination of two or more steps may be conducted simultaneously.

The complete disclosure of all patents, patent applications, and publications, and electronically available material cited herein are incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Throughout this disclosure, the tenu “and/or” means one or all of the listed elements or a combination of any two or more of the listed elements; the terms “comprises” and variations thereof do not have a limiting meaning where these terms appear in the description and claims; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

1. A method comprising:
providing a recipient with a plurality of potatoes in which at least 51% of the potatoes possess a specific gravity of at least 1.086.

2. A method comprising:
making a potato food product from a plurality of potatoes in which at least 51% of the potatoes possess a specific gravity of at least 1.086.

3. The method of claim 2 wherein the potato food product comprises French fries.

4. The method of claim 3 wherein the French fries comprise fresh-cut French fries.

5. The method of claim 2 wherein the food product comprises potato chips.

6. The method of claim 2 wherein the food product comprises acrylamide in an amount no greater than 500 ppb.

7. A food product prepared from a plurality of potatoes in which at least 51% of the potatoes possess a specific gravity of at least 1.086.

8. The food product of claim 7 comprising French fries.

9. The food product of claim 8 wherein the French fries comprise fresh-cut French fries.

10. The food product of claim 7 comprising potato chips.

11. The food product of claim 7 comprising hash browns.

12. The food product of claim 7 comprising acrylamide in an amount no greater than 500 ppb.

13. The food product of claim 7 further comprising a composite sensory grade of at least 7.0.

14. A system comprising:
a specific gravity meter; and
a selector in communication with the specific gravity meter and configured to separate potatoes having a specific gravity at least as great as a predetermined value from potatoes having a specific gravity less than the predetermined value.
